(19) United States
(12) Patent Application Publication
(10) Pub. No.: US 2009/0148244 A1
(43) Pub. Date: Jun. 11, 2009

(54) PNEUMATIC CONVEYING VELOCITY CONTROL DEVICE, APPARATUS AND METHOD

(75) Inventor: Brian Snowdon, Doncaster (GB)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: Clean Cat Technologies Limited, Glasgow (GB)

(21) Appl. No.: 11/993,740

(22) PCT Filed: Jun. 27, 2006
(86) PCT No.: PCT/GB2006/002363

§ 371 Date: Dec. 21, 2007

(30) Foreign Application Priority Data
Jun. 27, 2005 (GB) 0512998.6

(51) Int. Cl. B65G 53/66

(52) U.S. Cl. 406/28; 406/154; 406/191

(57) ABSTRACT

A device for controlling the velocity of a particulate material conveyed by a gas flow in a duct comprises means for separating the flow into first and second streams. The first stream has a relatively high particulate material content and the second stream has a relatively low particulate material content. The flow of the second stream is restricted for example by means of a flow-constricting orifice. The effect of the device is to increase the pressure of a vessel into which particulate material is discharged from the duct, thereby reducing the velocity of the material flow.

### FIELD OF THE INVENTION

This invention relates to the conveying of particulate matter suspended or entrained in a pressurised gas and conveyed with the gas along a duct at a controlled velocity. More particularly this invention relates to the conveyance of fragile particulate (especially granular) materials and especially to the conveyance of catalyst for and into oil refinery reactors.

### BACKGROUND TO THE INVENTION

Dense phase low velocity pneumatic conveying of dry fragile granular material is a well known concept which enables fragile granular material to be conveyed with low product breakage or dust generation.

This method of conveying is used for conveying products such as granulated sugar, soap powder, plastic pellets and catalyst used in oil refining reactors.

Low velocity dense phase conveying is normally achieved with the use of a ‘blow pot’ type of system which involves loading the material into a pressure vessel by gravity through an inlet valve in the top of the vessel, pressurising the vessel, opening an outlet valve in the base of the vessel which is connected to a conveying pipe, then pushing the material from the vessel into the conveying pipe with compressed gas until it is moved from the vessel into the conveying pipe. The outlet valve vessel is then closed and compressed gas may be put into the conveying pipe to keep the material moving as the vessel is depressurised through a vessel venting valve, and the vessel re-filled through the inlet valve. As soon as the vessel is full, the inlet valve is closed and the vessel pressurised to a pressure equal or higher than the conveying pipe before the outlet valve is opened, so that the material is pushed into the conveying pipe.

In this way, there are a number of vessel loads of material moving through the conveying pipe at the same time towards the receiving hopper or discharge point.

The pressure within the conveying vessel and the conveying pipe near the vessel will be at an elevated pressure which can, for example, be between 1 barg and 6 barg depending on the material being conveyed and the distance being conveyed.

If the receiving hopper or discharge point is at atmospheric pressure, the conveying gas will expand and the conveying velocity will increase as it progresses through the length of the conveying pipe.

For example, a system which operates with a starting pressure of 1 barg will double in velocity as it expands to atmospheric pressure. A system which starts at 4 barg pressure at the beginning of the system will have a velocity increase of 5 times the starting velocity by the time it gets to the receiving point or hopper.

It is well known in the industry that conveying pipe, and conveying pipe bend, wear and more importantly product breakage, is exponentially proportional to the conveying velocity to the power between 2.5 and 3.0.

It can be seen from the above that the majority of product breakage occurs towards the end of the conveying pipe, particularly where bends in pipe occur or discharge into the receiving point occur

One partial solution to this problem is to increase the diameter in steps along the length of the conveying pipe towards the receiving point to reduce this effect. At each increase in pipe diameter, the superficial conveying gas velocity drops as the conveying gas enters the larger pipe. Due to the large expansion in conveying gas which occurs, this expansion effect can be reduced but not eliminated.

One effect that cannot be eliminated or controlled is the phenomenon of the material to collect and move in ‘plugs’ with conveying gas between the plugs. This is a natural effect of low velocity dense phase conveying. Towards the end of the system these gas pockets expand rapidly and uncontrollably near to and into the receiving point (receiving vessel). This effect causes most of the product breakage on dense phase systems.

In addition to the type of dense phase conveying device described, there are other dense phase devices or methods of introducing material into the conveying pipe which have similar problems with conveying gas expansion to the one so far described.

For example, one alternative method is to use a large bulk storage transportable conveying device or tank, which may hold for example 15 m³ to 20 m³ of material to be conveyed. After conveying its contents to the receiving point, which can be carried out in one sequence or by a number of smaller batches, the vessel would be de-pressurised and taken away for re-filling. This method of operation with a large vessel in relation to the conveying pipe size can create more breakages than the smaller vessel ‘blow pot’ system due to the difficulty in controlling material velocity which is normally achieved by controlling the conveying gas flow in the vessel. The large vessel and compressive nature of the conveying gas results in fluctuations in vessel pressure and conveying velocity which do not respond quickly to changes in conveying gas flow to the vessel. There is also a tendency towards the end of the discharge period, as the vessel becomes empty, for the remaining contents to increase in velocity through the conveying pipe.

Another alternative method is the use of a so called ‘high pressure rotary valve’ or ‘airlock’ which can operate up to 3 barg pressure.

A further alternative method would be the use of a road or rail tanker which can be pressurised to convey the material to a storage silo.

An attempt to solve some of the above-mentioned problems is disclosed in WO/0039009 (Shultz International Application No. PCT/AU99/01138) whereby a constriction is provided at the end of the conveying pipe. The constriction is in the form of an annular orifice plate defining a central circular orifice which provides a discrete reduction of at least 20% in the effective cross-sectional area for the flow from the discharge end of the duct. This produces a discrete pressure drop of at least 5 kPa. However although this constriction limits the effects of expanding conveying gas towards the end of the conveying pipe, this method would cause severe damage to a fragile product as it comes into contact with the construction and also as it increases in velocity through the constriction and then impacts on the receiving hopper wall.

### BRIEF SUMMARY OF THE INVENTION

According to a first aspect of the present invention there is provided a device for controlling the velocity of particulate material being conveyed from a first location by means of a pressurised gas stream along a duct and into a second vessel at a second location, said device being configured to be located at or adjacent the discharge end of said duct and comprising means for separating the stream of particulate material and gas into a first stream containing a relatively high proportion of particulate material and a second stream containing a relatively low proportion of particulate material to gas, and means for restricting the gas flow in said second stream.

Whilst in WO/0039009 the particulate material is conveyed within the conveying gas through the restriction point, in the present invention the conveying gas and particulate matter are separated into different streams as they enter the device, and substantially only the conveying gas passes through the means for restricting the gas flow. As the particulate matter does not pass through the restriction to any significant extent it does not become damaged.

In a particularly preferred construction, the device includes an intermediate vessel operatively interposed between the duct and the vessel at the second location, the intermediate vessel including a flow aperture through which the second stream exits the vessel.

Preferably the means for restricting the gas flow in the second stream is a flow constricting orifice. Particularly preferably the orifice is within an annular orifice plate.

The restriction of flow of the venting of the conveying gas from the device leads to an elevation of pressure in the device to above atmospheric pressure. Operation of the device at above atmospheric pressure reduces the effect of gas expansion and also controls the flow of conveying gas from the device so as to eliminate the effect of rapidly expanding conveying gas pockets towards the end of the system.

Thus, in a preferred variation of this construction, the restriction of the gas flow in said second stream is such that the pressure in the intermediate vessel is greater than atmospheric pressure. It is especially preferred that the pressure within the intermediate vessel is at least 1 barg greater than atmospheric pressure with the result that the average velocity of the conveying gas at the discharge point (of the duct) is halved. By stopping the unstable rapid gas pocket expansion towards the end of the system, the product breakage is further reduced. The net effect of these velocity reductions is to reduce by 50% or more, the damage to the material caused by excessive conveying velocity.

In a further preferred embodiment the device of this aspect of the invention further comprises a valve operable to control the flow of conveying gas in said second stream. Preferably in this embodiment the device further comprises detection means operative to determine when the level of particulate material within the intermediate vessel has reached a predetermined level and wherein the valve is operable to prevent flow of conveyed particulate material into the device when said predetermined level is reached.

Preferably the particulate material is a granular material. In particular the particulate material may be a fragile particulate material. Preferably the particulate material is selected from the group comprising crystalline sugars, soap powder, plastic pellets, catalysts and similarly fragile materials. Catalysts can be particularly fragile one example comprising alumina ceramic needles of about 6 mm long and 0.5 mm in diameter. Conventionally catalyst is provided in large bags or drums which are lifted by a crane to the top of the oil refinery reactor, which can be some 40 m high, resulting inevitably in significant damage to the catalyst material.

The device of the present invention is especially suitable when the catalyst is for use in oil refinery reactors.

Most preferably the content of particulate material in the second stream is minimal. In this respect, minimum content of particulate material is such as to allow the second stream to be discharged (e.g. to atmosphere) with only conventional filtering or dust removal apparatus. Preferably the second stream is vented, directly or indirectly, to atmosphere.

According to a second aspect of the invention there is provided apparatus for conveying a particulate material from a first location to a second location at a controlled velocity, the apparatus comprising:
a duct having a first end and a second end, the first end being configured operatively to communicate with a first vessel in which the particulate material is initially disposed,
an intermediate vessel having an inlet communicating with the second end of the duct, and an outlet operable to allow particulate material to be transferred, directly or indirectly, from the intermediate vessel to the second location, a supply of pressurised conveying gas in fluid communication with the duct for conveying the particulate material through the duct,
the intermediate vessel further comprising a pressure control arrangement configured to maintain the pressure within the intermediate vessel greater than atmospheric pressure.

In a preferred embodiment of this aspect of the invention the apparatus further comprises said first vessel in which the particulate material is initially disposed and operatively configured to communicate with a first end of said duct. Preferably the first vessel is a pressure vessel.

Preferably in this embodiment said first vessel is selected from the group consisting of; a dense phase blow pot, an ISO-Veyor™, a rotary valve arrangement or a road/rail tanker. An example of an ISO-Veyor™ is described in WO2005/087622 the contents of which are incorporated herein by reference.

In another preferred embodiment of this aspect of the invention the pressure control arrangement includes means for separating the stream of particulate material and gas into a first stream containing a relatively high proportion of particulate material and a second stream containing a relatively low proportion of particulate material to gas, and means for restricting the gas flow in said second stream.

Preferably the pressure control arrangement includes means for venting the conveying gas from the intermediate vessel through a flow constricting orifice.

Preferably the means for restricting the gas flow in the second stream is a flow constricting orifice.

In preferred variations of the above embodiment, the content of particulate material in the second stream is minimal.

Preferably the second stream is vented, directly or indirectly, to atmosphere.

Preferably the orifice is within an annular orifice plate.

In further preferred embodiments, the apparatus further comprises a valve operable to control the flow of conveying gas in the vented gas stream.

Preferably in these embodiments the apparatus further comprises detection means operative to determine when the level of particulate material within the intermediate vessel has reached a predetermined level and wherein the valve is operable to prevent flow of conveyed particulate material into the intermediate vessel when said predetermined level is reached.

In particularly preferred embodiments the pressure within the intermediate vessel is at least 1 barg greater than atmospheric pressure. It is especially preferred that the pressure in the intermediate vessel is substantially constant.

Preferably the particulate material is a granular material.

Preferably the particulate material is a fragile particulate material.

Preferred particulate materials are selected from the group comprising crystalline sugars, soap powder, plastic pellets, catalysts and similarly fragile materials.

In preferred variations the catalyst is for use in oil refinery reactors.

In especially preferred embodiments the apparatus according to this aspect of the invention further comprises a pressure change arrangement including
a pressure change vessel having an inlet operatively connectable to the outlet of the intermediate vessel, and an outlet operable to allow particulate material to be discharged, directly or indirectly, to the second location,
a supply of pressurized gas operable to increase the pressure in the pressure change vessel
a vent operable to reduce the pressure in the pressure change vessel by venting conveying gas directly or indirectly to atmosphere,
whereby the pressure within the pressure change vessel may be equalised with that in the intermediate vessel for discharge of the particulate material from the intermediate vessel to the pressure change vessel and may be substantially equalised with atmospheric pressure for discharge of the particulate material from the pressure change vessel.

According to a third aspect of the invention there is provided apparatus for conveying a particulate material from a first location to a second vessel at a second location, said apparatus comprising a duct for conveying said particulate material from said first location to said second location, a vessel at said second location for receiving said particulate material and a device as defined above in the first aspect of the invention arranged at or adjacent the discharge end of said duct.

Preferably a lock hopper is located between the device and the second vessel in order to maintain a constant pressure in the device.

Preferably in this third aspect of the invention the apparatus further comprises said first vessel in which the particulate material is initially disposed and operatively configured to communicate with a first end of said duct.

Preferably the first vessel is selected from the group consisting of; a dense phase blow pot, an ISO-Veyor™, a rotary valve or a road/rail tanker.

Preferably the second vessel is an oil refinery reactor.

Preferably the particulate material being conveyed from the ISO-Veyor™ to the oil refinery reactor is catalyst.

According to a fourth aspect of the invention there is provided a method of controlling the velocity of flow of a particulate material within a conveyance gas along a conveyance duct positioned between two vessels, said method comprising locating a device at the discharge end of the conveyance duct, wherein said device wherein said device comprises means for separating the stream of particulate material and gas into first and second streams containing relatively high and low proportions respectively of particulate material to gas and means for restricting the gas flow in said second stream.

An example of a apparatus of the invention is one in which the apparatus comprises an ISO-Veyor™ as the first vessel and a oil refinery reactor as a second vessel. The use of the device according to the invention within this apparatus enables the transfer of catalyst from the ISO-Veyor™ to the oil refinery reactor with negligible or minimal structural damage to the catalyst.

### DETAILED DESCRIPTION OF THE DRAWINGS

For a better understanding of the invention and to show how the same may be carried into effect, reference will be made, by way of example only, to the following drawings, in which:

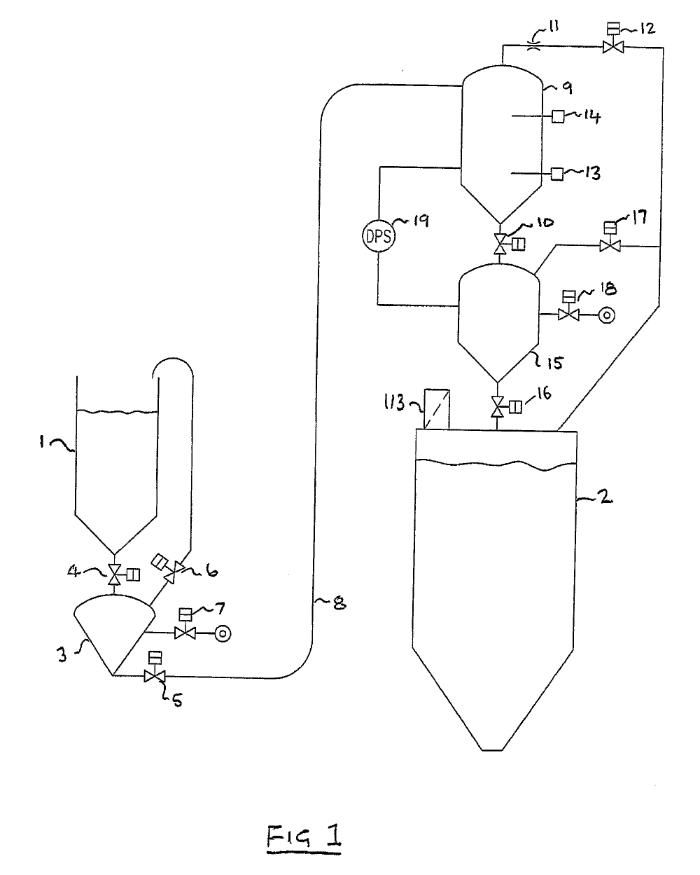

FIG. 1 shows a schematic illustration of a device and apparatus according to the invention using a dense phase blow pot.

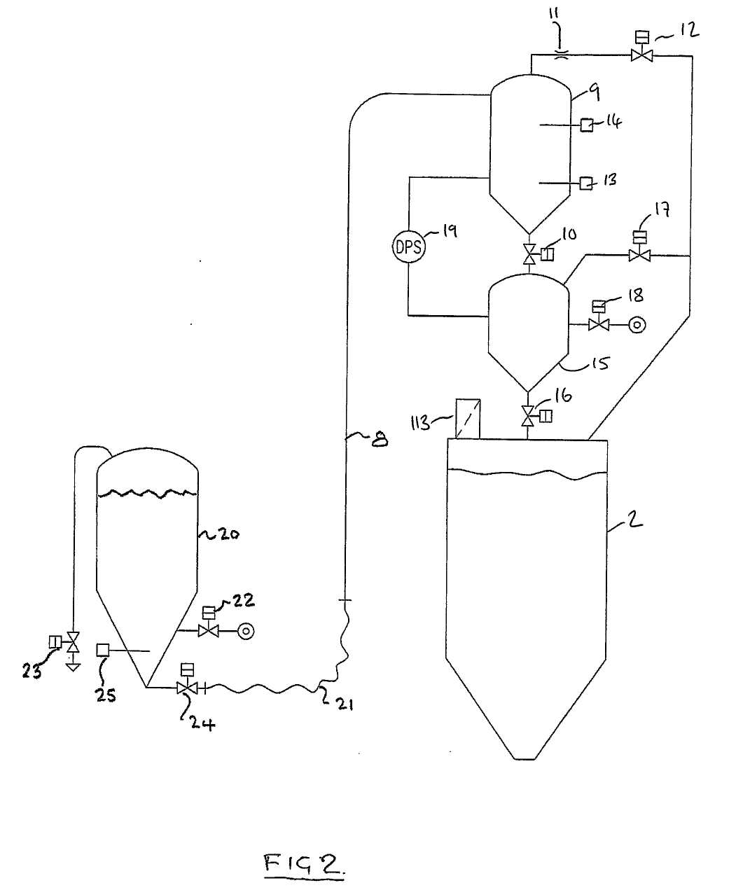

FIG. 2 shows a schematic illustration of a device and apparatus according to the invention using a using a large bulk storage transportable vessel.

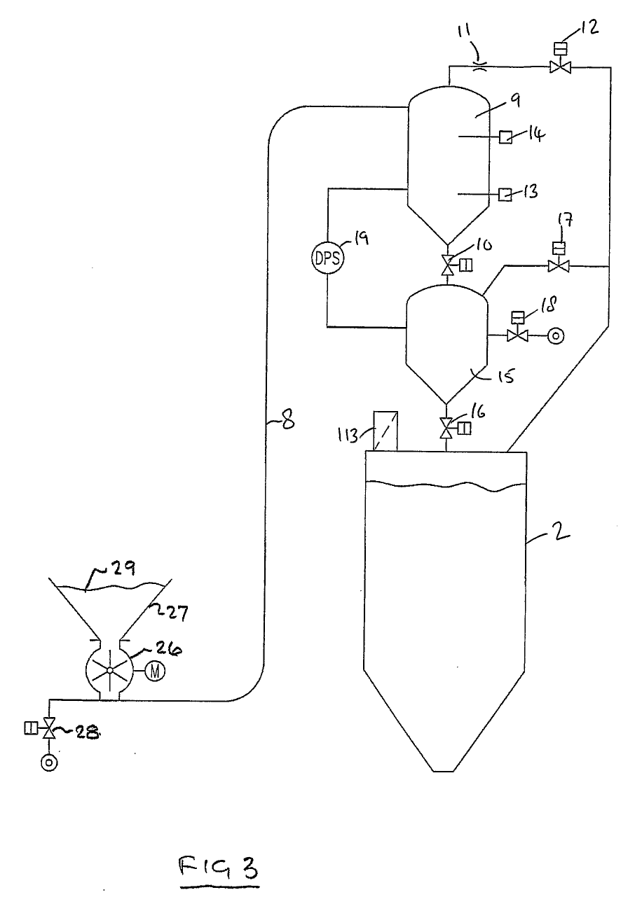

FIG. 3 shows a schematic illustration of a device and apparatus according to the invention using a using a rotary valve.

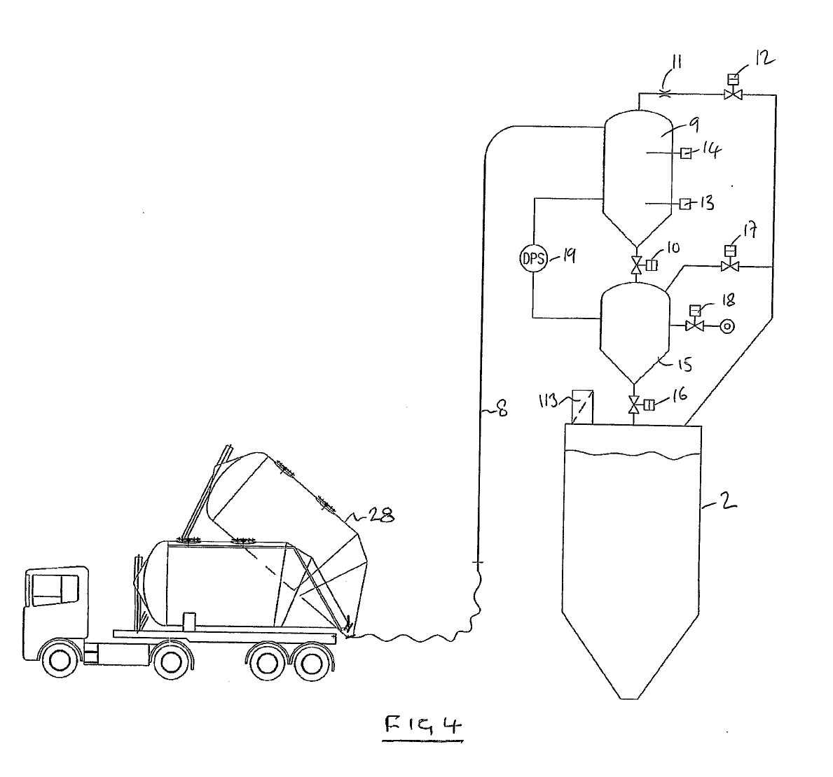

FIG. 4 shows a schematic illustration of a device and apparatus according to the invention using a using a road/rail tanker.

FIG. 1 shows the device and apparatus of the invention using a dense phase blowpot system. Storage hopper 1 (forming the first location of the particulate material) holds material which is to be conveyed to storage hopper 2 (forming the second location of the particulate material). For transfer of the particulate material into blowpot 3, initially conveying air valve 7 and the outlet valve 5 are closed. Vent valve 6 is open. Blowpot 3 is filled by gravity through open inlet valve 4. When the first vessel (blowpot) 3 is full, the inlet valve 4 and vent valve 6 close. Conveying gas inlet valve 7 and the outlet valve 5 now open and material is conveyed down pipe (duct) 8 towards intermediate vessel 9. Intermediate vessel 9 has an outlet valve 10. The intermediate vessel 9 has an outlet whereby conveying gas vents from vessel 9 through constricting orifice 11. Thus the stream of particulate material and gas separates into a first stream containing a relatively high proportion of particulate material which is retained in the intermediate vessel and a second stream containing a relatively low proportion of particulate material to gas which vents through orifice 11 and valve 12 into hopper 2 which has a venting filter 113. This vented conveying gas may alternatively be vented to a separate filtration system if required.

Vessel 9 is relatively small. By controlling the vent flow from vessel 9 into orifice 11, it is possible to raise the pressure at the receiving point (that is, the discharge point of duct 8 into intermediate vessel 9) and therefore reduce the effects of gas expansion previously described. The raised pressure and controlled flow also considerably reduce the effect of rapid gas expansion into the receiving point. Valve 12 can also be used to stop material flow into vessel 9 if vessel 9 becomes overfilled, as detected by level switch 14 or by a calculation based on level switch 13 being covered for a given predetermined time period.

To maintain a substantially constant flow of conveying gas through vessel 9 and a substantially constant pressure, it is desirable to fit a lock hopper 15 between vessel 9 and hopper 2. Lock hopper 15 is also a pressure vessel which is connected to intermediate vessel 9 by outlet 10. Lock hopper 15 has a vent line controlled by valve 17 and a pressurized gas supply controlled by valve 18. The outlet of lock hopper 15 is controlled by valve 16. Initially before there is sufficient material in vessel 9 to cover level switch 13, inlet valve 10, outlet valve 16, vent valve 17 and gas inlet valve 18 are closed. When level switch 13 is covered by material, valve 18 opens, increasing the pressure in vessel 15 until it is the same as vessel 9, indicated by differential pressure switch or transducer 19 when valve 18 closes. Inlet valve 10 now opens and contents of vessel 9 fall into vessel (lock hopper) 15. After a time period valve 10 closes and vent valve 17 opens, allowing the vessel pressure to vent into hopper 2 or other dust extraction system. When the pressure in vessel 15 reaches atmospheric pressure valve 16 opens, allowing the material to flow by gravity into hopper 2. When vessel 15 is empty, valve 16 closes and the lock hopper 15 is ready to cycle again when level switch 13 is covered. During the period when the lock hopper is in operation, material continues to be conveyed into vessel 9.

FIG. 2 shows the device being used with a large transportable bulk storage vessel 20.

This vessel is normally connected to the conveying pipe (duct) 8 with a flexible hose 21. The operating method for this large vessel system is to open gas inlet valve 22. Pressure let down valve 23 and outlet valve 24 are closed. At a pressure sufficient to convey the material, valve 24 is opened and conveying commences. The velocity controlling device operates as previously described until the bulk storage vessel 20 is empty as indicated by level switch 25 or a weighing system connected to vessel 20. When vessel 20 is empty, the pressure in vessel 20 may be allowed to dissipate through the conveying pipe to the velocity control device or by opening vent valve 23 after closing gas inlet valve 22.

FIG. 3 shows the basic concept using a rotary valve 26. This type of valve may also be known as an airlock and can operate up to a pressure of 3 barg.

Rotary valve 26 is operated by a motor and moves materials 29 from an atmospheric feed hopper 27 into the conveying pipe 8. The velocity control device will operate as previously described with the additional function of stopping rotary valve 26 and closing conveying gas valve 28 when level switch 14 is covered, then starting the rotary valve and opening the conveying gas valve again as level switch 14 becomes uncovered.

FIG. 4 shows the basic concept being used with a road or rail tanker 28. Road tankers for bulk granular materials may be a ‘tipping’ type as shown or a non-tipping type which has multiple outlets connected to a common discharge pipe. The non-tipping type method is also used on rail tankers. Both of these types are well known in the industry but are not currently used for very fragile materials because of the material breakage which occurs when unloading.

Both the tipping and non tipping type of pneumatic bulk transport tanker will operate in a similar way to the transportable tank shown in FIG. 2.

1. A device for controlling the velocity of particulate material being conveyed from a first location by means of a pressurized gas stream along a duct and into a second vessel at a second location, said device being configured to be located at or adjacent the discharge end of said duct and comprising means for separating the stream of particulate material and gas into a first stream containing a relatively high proportion of particulate material and a second stream containing a relatively low proportion of particulate material to gas, and means for restricting the gas flow in said second stream.

2. A device as claimed in claim 1 wherein the device includes an intermediate vessel operatively interposed between the duct and the vessel at the second location, the intermediate vessel including a flow aperture through which the second stream exits the vessel.

3. A device as claimed in claim 1 wherein the means for restricting the gas flow in the second stream is a flow constricting orifice.

4. A device as claimed in claim 3 wherein the orifice is within an annular orifice plate.

5. A device as claimed in claim 2, wherein the restriction of the gas flow in said second stream is such that the pressure in the intermediate vessel is greater than atmospheric pressure.

6. A device as claimed in claim 5 wherein the pressure within the intermediate vessel is at least 1 barg greater than atmospheric pressure.

7. A device as claimed in claim 2 further comprising a valve operable to control the flow of conveying gas in said second stream.

8. A device as claimed in claim 7 further comprising detection means operative to determine when the level of particulate material within the intermediate vessel has reached a predetermined level and wherein the valve is operable to prevent flow of conveyed particulate material into the device when said predetermined level is reached.

9. A device as claimed in claim 1 wherein the particulate material is a granular material.

10. A device as claimed in claim 1 wherein the particulate material is a fragile particulate material.

11. A device as claimed in claim 1 wherein the particulate material is selected from the group comprising crystalline sugars, soap powder, plastic pellets, catalysts and similarly fragile materials.

12. A device as claimed in claim 11, wherein the catalyst is for use in oil refinery reactors.

13. A device as claimed in claim 1 wherein the content of particulate material in the second stream is minimal.

14. A device as claimed in claim 1 wherein the second stream is vented, directly or indirectly, to atmosphere.

15. Apparatus for conveying a particulate material from a first location to a second location at a controlled velocity, the apparatus comprising: a duct having a first end and a second end, the first end being configured operatively to communicate with a first vessel in which the particulate material is initially disposed, an intermediate vessel having an inlet communicating with the second end of the duct, and an outlet operable to allow particulate material to be transferred, directly or indirectly, from the intermediate vessel to the second location, a supply of pressurized conveying gas in fluid communication with the duct for conveying the particulate material through the duct, the intermediate vessel further comprising a pressure control arrangement configured to maintain the pressure within the intermediate vessel greater than atmospheric pressure.

16. Apparatus as claimed in claim 15 further comprising said first vessel in which the particulate material is initially disposed and operatively configured to communicate with a first end of said duct.

17. An apparatus as claimed in claim 16 wherein said first vessel is selected from the group consisting of; a dense phase blow pot, an ISO-Veyor™, a rotary valve arrangement or a road/rail tanker.

18. Apparatus as claimed in claim 15 wherein the pressure control arrangement includes means for separating the stream of particulate material and gas into a first stream containing a relatively high proportion of particulate material and a second stream containing a relatively low proportion of particulate material to gas, and means for restricting the gas flow in said second stream.

19. Apparatus as claimed in claim 15 wherein the pressure control arrangement includes means for venting the conveying gas from the intermediate vessel through a flow constricting orifice.

20. Apparatus as claimed in claim 18 wherein the means for restricting the gas flow in the second stream is a flow constricting orifice.

21. Apparatus as claimed in claim 18 wherein the content of particulate material in the second stream is minimal.

22. A device as claimed in claim 18 wherein the second stream is vented, directly or indirectly, to atmosphere.

23. Apparatus as claimed in claim 19 wherein the orifice is within an annular orifice plate.

24. Apparatus as claimed in claim 19 further comprising a valve operable to control the flow of conveying gas in the vented gas stream.

25. Apparatus as claimed in claim 24 further comprising detection means operative to determine when the level of particulate material within the intermediate vessel has reached a predetermined level and wherein the valve is operable to prevent flow of conveyed particulate material into the intermediate vessel when said predetermined level is reached.

26. Apparatus as claimed in claim 15 wherein the pressure within the intermediate vessel is at least 1 barg greater than atmospheric pressure.

27. Apparatus as claimed in claim 15 wherein the particulate material is a granular material.

28. Apparatus as claimed in claim 15 wherein the particulate material is a fragile particulate material.

29. Apparatus as claimed in claim 15 wherein the particulate material is selected from the group comprising crystalline sugars, soap powder, plastic pellets, catalysts and similarly fragile materials.

30. Apparatus as claimed in claim 29, wherein the catalyst is for use in oil refinery reactors.

31. Apparatus as claimed in claim 15 further comprising:
a pressure change arrangement including
a pressure change vessel having an inlet operatively connectable to the outlet of the intermediate vessel, and an outlet operable to allow particulate material to be discharged, directly or indirectly, to the second location,
a supply of pressurized gas operable to increase the pressure in the pressure change vessel, and
a vent operable to reduce the pressure in the pressure change vessel by venting conveying gas directly or indirectly to atmosphere,
whereby the pressure within the pressure change vessel may be equalized with that in the intermediate vessel for discharge of the particulate material from the intermediate vessel to the pressure change vessel and may be substantially equalized with atmospheric pressure for discharge of the particulate material from the pressure change vessel.

32. Apparatus for conveying a particulate material from a first location to a second vessel at a second location, said apparatus comprising a duct for conveying said particulate material from said first location to said second location, a vessel at said second location for receiving said particulate material and a device as claimed in claim 1 arranged at or adjacent the discharge end of said duct.

33. Apparatus according to claim 32 wherein a lock hopper is located between the device and the second vessel in order to maintain a constant pressure in the device.

34. Apparatus as claimed in claim 32 further comprising said first vessel in which the particulate material is initially disposed and operatively configured to communicate with a first end of said duct.

35. Apparatus according to claim 34 wherein the first vessel is selected from the group consisting of; a dense phase blow pot, an ISO-Veyor™, a rotary valve or a road/rail tanker.

36. Apparatus according to claim 32 wherein the second vessel is an oil refinery reactor.

37. Apparatus according to claim 36, wherein the particulate material being conveyed from the ISO-Veyor™ to the oil refinery reactor is catalyst.

38. A method of controlling the velocity of flow of a particulate material within a conveyance gas along a conveyance duct positioned between two vessels, said method comprising locating a device at the discharge end of the conveyance duct, wherein said device wherein said device comprises means for separating the stream of particulate material and gas into first and second streams containing relatively high and low proportions respectively of particulate material to gas and means for restricting the gas flow in said second stream.

39. (canceled)

40. (canceled)
